(19) United States
(12) Patent Application Publication
(10) Pub. No.: US 2017/0163992 A1
(43) Pub. Date: Jun. 8, 2017

(54) VIDEO COMPRESSING AND PLAYING METHOD AND DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Xiangen LU, Tianjin (CN)

(21) Appl. No.: 15/250,002

(22) Filed: Aug. 29, 2016

Related U.S. Application Data
(63) Continuation of application No. PCT/CN2016/089349, filed on Jul. 8, 2016.

(30) Foreign Application Priority Data
Dec. 3, 2015 (CN) 201510883624.7

(51) Int. Cl. H04N 19/179; H04N 19/87; H04N 19/142; H04N 19/46; G06K 9/00; H04N 19/119

(52) U.S. Cl. CPC H04N 19/179; G06K 9/00765; H04N 19/119; H04N 19/142; H04N 19/46; H04N 19/87

(57) ABSTRACT

Embodiments of the present disclosure provide video compressing and playing methods as well as devices. The video compressing method comprises determining in advance partitioning information of video data in accordance with scenes, partitioning the video data according to the partitioning information to determine video segments corresponding to the scenes and start key frames of the video segments, and coding in sequence the video segments corresponding to the scenes according to the start key frames to generate coded video data and a corresponding scene information table, such that a player decodes the coded video data according to the scene information table. The method is used in video coding compression processes, and unifies a partitioning standard and a coding standard for videos. The generated scene information table may also serve as a basis for subsequent operations such as video decoding, playing, editing, and so on.

### CROSS-REFERENCE TO RELATED APPLICATIONS

This application is a continuation of International Application No. PCT/CN2016/089349 filed on Jul. 8, 2016, which is based upon and claims priority to Chinese Patent Application No. 201510883624.7, entitled “VIDEO COMPRESSING AND PLAYING METHOD AND DEVICE”, filed Dec. 3, 2015, and the entire contents of all of which are incorporated herein by reference.

### TECHNICAL FIELD

The present disclosure generally relates to the field of multimedia, and in particular, to video compressing and playing methods as well as video compressing and playing devices.

### BACKGROUND

At present, an existing video segmenting method includes segmenting and cropping a complete video into a plurality of video segments, but it is likely that one or more scenes are included in a certain segment. It is also likely that a certain scene includes one or more segments.

The inventor has found out in the process of implementing the present disclosure that subsequent compressing, decoding, and playing of a video are greatly affected because of the disunity of video segmenting standards. For example, it cannot be guaranteed that a start frame of each scene is I frame when the scene is switched in a video coding process. Generally and averagely, a compression ratio of I frame is 7, while that of P frame is 20 and that of B frame may reach 50. If the start frame of a present scene is P frame or B frame, when a new scene is coded, a too high compression ratio results in missing critical data after coding, thereby leading to a bad video compression effect.

Hence, the problem to be solved by those skilled in the art is to provide video compressing and playing methods as well as devices to solve the problem of the disunity of video processing standards in the prior art.

### SUMMARY

Embodiments of the present disclosure disclose video compressing and playing methods as well as devices to solve the problem of the disunity of the video processing standards in the prior art.

An embodiment of the present disclosure discloses a video compressing method, including: at an electronic device: determining in advance partitioning information of video data in accordance with scenes; partitioning the video data according to the partitioning information to determine video segments corresponding to the scenes and start key frames of the video segments; coding in sequence the video segments corresponding to the scenes according to the start key frames to generate coded video data and a corresponding scene information table, such that a player decodes the coded video data according to the scene information table.

Correspondingly, an embodiment of the present disclosure discloses an electronic device for video compressing, including: at least one processor; and a memory communicably connected with the at least one processor for storing instructions executable by the at least one processor, wherein execution of the instructions by the at least one processor causes the at least one processor to: determine in advance partitioning information of video data in accordance with scenes; partition the video data according to the partitioning information to determine video segments corresponding to the scenes and start key frames of the video segments; code in sequence the video segments corresponding to the scenes according to the start key frames to generate coded video data and a corresponding scene information table, such that a player decodes the coded video data according to the scene information table.

An embodiment of the present disclosure discloses a non-transitory computer readable medium, storing executable instructions that, when executed by a play device, cause the play device to: determine in advance partitioning information of video data in accordance with scenes; partition the video data according to the partitioning information to determine video segments corresponding to the scenes and start key frames of the video segments; code in sequence the video segments corresponding to the scenes according to the start key frames to generate coded video data and a corresponding scene information table, such that a player decodes the coded video data according to the scene information table.

According to the video compressing and playing methods as well as devices provided by the embodiments of the present disclosure, a partitioning standard and a coding standard for videos are unified by way of determining in advance partitioning information of video data in accordance with scenes, partitioning the video data according to the partitioning information to determine video segments corresponding to the scenes and start key frames of the video segments, and coding in sequence the video segments corresponding to the scenes according to the start key frames to generate coded video data and a corresponding scene information table. The video segments are partitioned by the scenes, and each video segment is coded starting from the start key frame thereof, in this way, the compression ratio of the video data can be increased while the compression effect of each scene is ensured.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow diagram of a video compressing method in accordance with some embodiments.

FIG. 2 is a step flow diagram of a video compressing method in accordance with some embodiments.

FIG. 3 is a step flow diagram of a video playing method in accordance with some embodiments.

FIG. 4 is a step flow diagram of a video playing method in accordance with some embodiments.

FIG. 5 is a structure block diagram of a video compressing device in accordance with some embodiments.

FIG. 6 is a structure block diagram of a video compressing device in accordance with some embodiments.

FIG. 7 is a structure block diagram of a video playing device in accordance with some embodiments.

FIG. 8 is a structure block diagram of a video playing device in accordance with some embodiments.

FIG. 9 schematically shows a block diagram of an electronic device for executing methods in accordance with some embodiments.

### DETAILED DESCRIPTION

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure, but not all embodiments. On the basis of the embodiments in the present disclosure, all the other embodiments obtained by a person skilled in the art without creative work should fall into the scope of protection of the present disclosure.

In the prior art, the disunity of standards in such processes as video recording, coding, decoding, playing and editing leads to inconvenience in various aspects for a user when processing videos. For example, when a video is segmented, due to the disunity of the segmenting standards, it is likely that one or more scenes are included in a segment or a scene includes more segments. Further, for example, in case that the start frame of each segment is not I frame, it is inconvenient for coding and decoding the video data.

Hence, the core concept of the embodiments of the present disclosure is enabling scenes to correspond to video segments, i.e., segmenting video data according to the scenes, and thereby determining the standards of video data coding, decoding and playing.

### A First Embodiment

By referring to FIG. 1, which shows the step flow diagram of the video compressing method of one embodiment of the present disclosure, the method may specifically include the steps as follows.

Step S102, partitioning information of video data is determined in advance in accordance with scenes.

In the initial recording process of a video, the time of switching each scene is recorded. After recording is completed, the completely recorded video data is preprocessed before cording to determine each scene in the video data according to the time of switching each scene recorded in the recording process, wherein each scene corresponds to scene information; the scene information and the scene switching time of each scene are regarded as the partitioning information of the video data.

Step S104, the video data is partitioned according to the partitioning information to determine video segments corresponding to the scenes and start key frames of the video segments.

The scene information corresponding to each scene and the switching time of each scene in the partitioning information are sought, thereby determining the video segment corresponding to each scene.

A start frame of each video segment is sought in sequence, and configured as the start key frame. The purpose of configuring the start key frame is to enable each video segment to be coded or decoded starting from the start key frame, wherein the start key frame may include I frame.

Step S106, the video segments corresponding to the scenes are coded in sequence according to the start key frames to generate coded video data and a corresponding scene information table.

In the coding process, the video segment corresponding to the first scene and coding begins from the start key frame of the first video frame. Afterwards, coding is continued starting from the start key frame of the video segment corresponding to the second scene. In this way, the video segments are coded in sequence. During coding, the position information of the start key frame of each video segment in the coded video data is also recorded in sequence.

The compression ratio of the start key frames is relatively low to ensure that the basic framework of the image data of each video segment is saved at the beginning of coding the video segment, thereby providing more options on P frames or B frames for subsequent frame data. The compression ratio of the P frames and the B frames are high, such that the compression ratio of the video is increased.

After completing coding, the coded video data is obtained, accompanying with the specific position data of the start key frame of each video segment in the coded video data. The corresponding scene information table is generated by the position data.

The scene information table mentioned above is a basis for subsequently decoding and playing the coded video data, such that a player decodes the coded video data according to the scene information table.

According to this embodiment of the present disclosure, the partitioning standard and the coding standard for the video are unified by way of determining in advance the partitioning information of the video data in accordance with the scenes, partitioning the video data according to the partitioning information to determine the video segments corresponding to the scenes and the start key frames of the video segments, and coding in sequence the video segments corresponding to the scenes according to the start key frames to generate the coded video data and the corresponding scene information table. The video segments are partitioned by the scenes, and each video segment is coded starting from the start key frame thereof; in this way, the compression ratio of the video data can be increased while the compression effect of each scene is ensured.

### A Second Embodiment

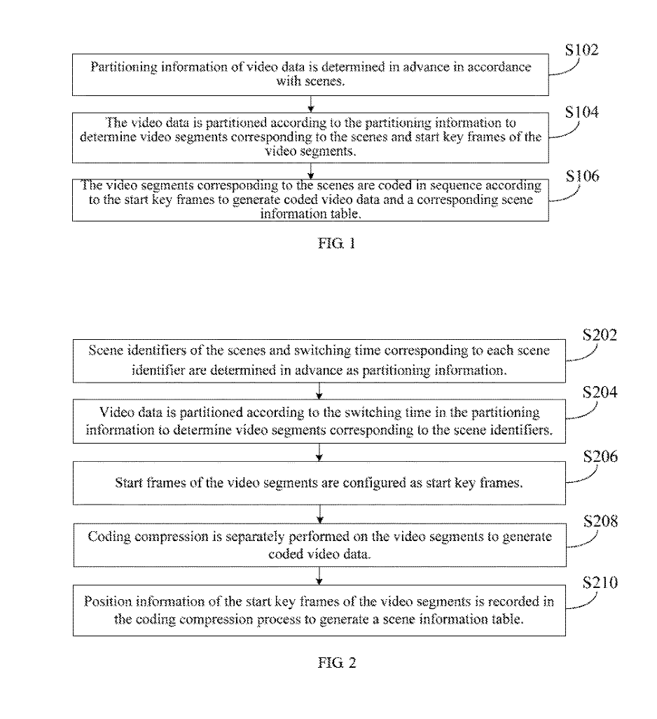

By referring to FIG. 2, which shows the step flow diagram of the video compressing method of another embodiment of the present disclosure, the method may specifically include the steps as follows.

Step S202, scene identifiers of the scenes and switching time corresponding to each scene identifier are determined in advance as partitioning information.

In the initial recording process of a video, the time of switching each scene is recorded. After recording is completed, the completely recorded video data is preprocessed before cording to determine each scene in the video data according to the time of switching each scene recorded in the recording process, wherein each scene corresponds to a scene identifier; the scene identifier and the scene switching time of each scene are regarded as the partitioning information of the video data. For example, in the video recording process, the entire video data is recorded in advance in accordance with the scenes that are numbered.

In the process of recording video segments, the starting time and finishing time of recording each video segment, i.e., the time of switching the scene, are recorded. When one scene is completely recorded, and switched to next scene for recording, the time is recorded. In this way, each video segment corresponds to a scene switching time.

The scene identifiers corresponding to the video segments and the switching time corresponding to each scene are regarded as the partitioning information, such that the recorded video data is segmented in accordance with the partitioning information to facilitate the subsequent coding step.

For example, there is video data including three scenes that are recorded for 30 S, 60 S, and 90 S in sequence, and the three scenes thus are numbered as scene 1, scene 2, and scene 3, then, the corresponding scene switching time is 0 S, 30 S, and 90 S.

Step S204, video data is partitioned according to the switching time in the partitioning information to determine video segments corresponding to the scene identifiers.

In regard to a complete video, the video has corresponding playing time, i.e., the duration of the video, such as 90 minutes, 120 minutes, and the like. The video data may be partitioned into a plurality of video segments according to the time of switching each scene in the partitioning information, and each video segment corresponds to one scene. The partitioning information also includes the scene identifiers. The scenes may be enabled to correspond to the video segments one to one according to the scene identifiers. For example, the video segments are determined according to the scene identifiers.

Step S206, start frames of the video segments are configured as start key frames.

After the video segments are determined completely, the start frames of the video segments are sought and configured as the start key frames, wherein each start key frame includes I frame which is also referred to as a key frame. Generally, a compression ratio of I frame is 7, while that of P frame is 20 and that of B frame may reach 50. The I frame is used as the start frame because the low compression ratio of the I frame is capable of ensuring that the basic framework of the image data of each video segment is saved at the beginning of coding the video segment, thereby providing more options on P frames or B frames for subsequent frame data. In this way, the compression ratio of the video is increased.

Step S208, coding compression is separately performed on the video segments to generate coded video data.

Step S210, position information of the start key frames of the video segments is recorded in the coding compression process to generate a scene information table.

All the video segments are sought to determine the video segment corresponding to the first scene, and coding begins from the start key frame. Afterwards, coding is continued starting from the start key frame of the video segment corresponding to the second scene. In this way, the video segments are coded in sequence to obtain the coded video data. Meanwhile, when each video segment is coded, the position information of the start key frame of this video segment in the entire coded video data is recorded. Thus, after all the video segments are coded completely, the scene information table is generated by the position information of the start key frames of all the video segments in the entire coded video data. The scene information table is a basis for subsequently decoding and playing the coded video data, such that a player decodes the coded video data according to the scene information table.

In order to solve the problem of excessively low seek efficiency, the number of the I frames may also be appropriately increased according to the duration of the video segment corresponding to each scene in this embodiment of the present disclosure.

As a preferred embodiment of the present disclosure, extension is carried out in the video coding stand and the data organization format of the system layer to add a table definition, such that when a video is coded, the position information of the start key frame of each video segment in the coded video data is recorded to generate the scene information table. As a result, subsequent video decoding, playing, editing and the like all can be carried out according to the scene information table.

By taking a mp4 file as an example,

a scene information table similar to stco, i.e., Scene offset box, is defined by a user, in which the offset of the starting position of each scene (a complete scene is called as a scene) is saved. According to how many scenes included in a video, the length of the box is defined as the length of 64-bit offset data pieces as many as the scenes.

If a video includes 20 scenes, the scene offset box is defined as follows:

| | |
|---|---|
| Size: | 164 (20*8 + 4 + 4); |
| type: | uuid (representing user-defined); |
| sub-type: | stso (representing scene offset box); |
| offset1 | (8-byte value): the offset of the first scene; |
| offset2 | (8-byte value): the offset of the second scene; |
| offset3 | (8-byte value): the offset of the third scene; |
| . . . | |

Offset20 (8-byte value): the offset of the 20^{th} scene.

For an existing video (a video coded, but including no scene table information), software is used to analyze the content of the video or a manual intervention way is utilized to transcode the video to generate the scene information table.

According to this embodiment of the present disclosure, the partitioning standard and the coding standard for the video are unified by way of determining in advance the scene identifiers of the scenes and the switching time corresponding to each scene identifier as the partitioning information, partitioning the video data according to the switching time in the partitioning information to determine the video segments corresponding to the scene identifiers, configuring the start frames of the video segments as the start key frames, separately performing coding compression on the video segments to generate the coded video data, and recording in the coding compression process the position information of the start key frames of the video segments to generate the scene information table. The video segments are partitioned by the scenes, and each scene has the scene identifier; moreover, each video segment is coded starting from the start key frame thereof. In this way, the compression ratio of the video data can be increased while the compression effect of each scene is ensured. The position information of the start key frame of each video segment in the entire video data to provide a basis for subsequent video decoding, playing, editing, etc.

### A Third Embodiment

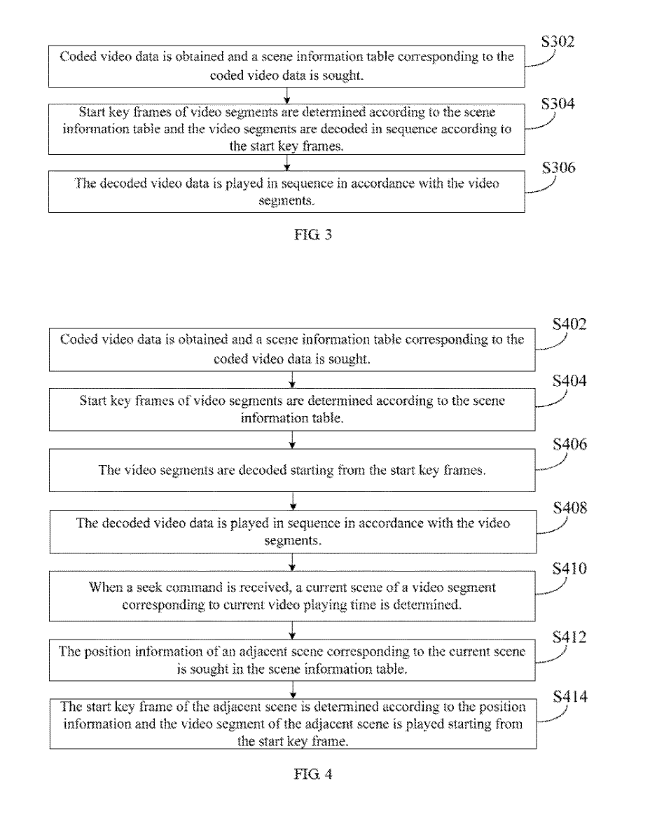

By referring to FIG. 3, which shows the step flow diagram of the video playing method of one embodiment of the present disclosure, the method may specifically include the steps as follows.

Step S302, coded video data is obtained and a scene information table corresponding to the coded video data is sought.

When a player receives a video playing command, the player obtains the coded video data corresponding to the video to be played according to the video playing command, and seeks the scene information table corresponding to the coded video data according to the coded video data, so that a decoder can subsequently decode the coded video data according to the scene information table.

Step S304, start key frames of video segments are determined according to the scene information table and the video segments are decoded in sequence according to the start key frames.

Step S306, the decoded video data is played in sequence in accordance with the video segments.

The position of the start key frame of each video segment recorded in the scene information table obtained through parsing, and the video segments are decoded in sequence starting from the first start key frame in the coded video data.

The decoded video segment data may be from different servers. In this case, the scenes corresponding to the video segments obtained through decoding may be determined according to the scene information table, and the video segments are sorted according to the scenes and then played in sequence.

If a certain video segment cannot be downloaded for a data source problem or a network problem and the decoded data thus cannot be obtained, the video segment may be skipped over and next video segment is directly played because the video segments are partitioned on the basis of the scenes in this embodiment of the present disclosure and each are independent, and missing of a certain video segment, namely a certain scene, does not affect playing of the entire video.

According to this embodiment of the present disclosure, the coded video data is obtained and the scene information table corresponding to the coded video data is sought; the start key frames of the video segments are determined according to the scene information table and the video segments are decoded in sequence according to the start key frames, the decoded video data is played in sequence in accordance with the video segments. As a result, decoding is based on the scene information table in the coding process to ensure that the start frame of each video segment is the start key frame when the video segment is decoded; therefore, the player is able to quickly decode the video data of the video segment by means of the start key frame.

### A Fourth Embodiment

By referring to FIG. 4, which shows the step flow diagram of the video playing method of another embodiment of the present disclosure, the method may specifically include the steps as follows.

Step S402, coded video data is obtained and a scene information table corresponding to the coded video data is sought.

When a player receives a video playing command, the player obtains the coded video data corresponding to the video to be played according to the video playing command, and seeks the scene information table corresponding to the coded video data according to the coded video data, so that a decoder can subsequently decode the coded video data according to the scene information table.

Step S404, start key frames of video segments are determined according to the scene information table.

Step S406, the video segments are decoded starting from the start key frames.

Step S408, the decoded video data is played in sequence in accordance with the video segments.

The position information of the start key frame of each video segment in the scene information table obtained through parsing is sought, and the position information of all the start key frames in the entire coded video data is determined. The video segment data obtained by decoding in sequence the video segments starting from the first start key frame in the coded video data may be from different servers. In this case, the scenes corresponding to the video segments obtained through decoding are determined according to the scene information table, and the video segments are sorted according to the scenes and then played in sequence.

Step S410, when a seek command is received, a current scene of a video segment corresponding to current video playing time is determined.

Upon receiving the seek command, the player seeks the video segment corresponding to the current playing time and determines the scene corresponding to the current video segment according to the video segment.

The seek command therein may include a fast forward command, namely a command of seeking next scene, and may also include a fast backward command, namely a command of seeking previous scene.

Step S412, the position information of an adjacent scene corresponding to the current scene is sought in the scene information table.

Step S414, the start key frame of the adjacent scene is determined according to the position information and the video segment of the adjacent scene is played starting from the start key frame.

The video segment of the adjacent scene corresponding to the current scene is sought in the scene information table according to the seek command, and the position information of the video segment is determined; moreover, the start key frame of the video segment is sought, such that the video segment of the adjacent scene is played starting from the start key frame, wherein the adjacent scene include the previous scene or the next scene.

For example, if the video segment played currently is numbered as scene 6, when the fast forward command is received, the command of seeking the video segment corresponding to the next scene is sent and the video segment current played is obtained as scene 6 according to the fast forward command; next, the video segment numbered as scene 7 is determined according to the command of seeking the video segment corresponding to the next scene, and the start key frame of the video segment of scene 7 is determined. The video segment corresponding to scene 7 is played starting from the scene start key frame of the video segment of scene 7.

According to this embodiment of the present disclosure, the coded video data is obtained and the scene information table corresponding to the coded video data is sought, the start key frames of video segments are determined according to the position information in the scene information table and the video segments are decoded starting from the start key frames; the decoded video data is played in sequence in accordance with the video segments. As a result, decoding is based on the scene information table in the coding process to ensure that the start frame of each video segment is the start key frame when the video segment is decoded; therefore, the player is able to quickly decode the video data of the video segment by means of the start key frame.

This embodiment of the present disclosure also provides users a new mode of watching a video. On the basis of video data obtained after decoding, the number of scenes included in the video data can be obtained, and a thumbnail of a scene corresponding to each video segment can be conveniently obtained at the beginning of the video segment. Therefore, the general content of the video can be obtained quickly.

According to this embodiment of the present disclosure, the scenes can be switched to play in units of fast forward or fast backward by an entire scene. For video editing software, the sequence of the video segments can be adjusted, or some video segments can be added or deleted. In the units of scenes, processing on video data may not lead to a disorder of the video because of scene addition, scene deletion or scene sequence change.

It needs to be noted that in regard to the method embodiments, for the sake of simple descriptions, they are all expressed as combinations of a series of actions; however, a person skilled in the art should know that the embodiments of the present disclosure are not limited by the described order of actions, because some steps may be carried out in other orders or simultaneously according to the embodiments of the present disclosure. For another, a person skilled in the art should also know that the embodiments described in the description all are preferred embodiments, and the actions involved therein are not necessary for the embodiments of the present disclosure.

### A Fifth Embodiment

By Referring to FIG. 5, which shows the structure block diagram of the video compressing device of one embodiment of the present disclosure, the device may specifically include the modules as follows.

An information determining module 502 configured to determine in advance partitioning information of video data in accordance with scenes; a segment determining module 504 configured to partition the video data according to the partitioning information to determine video segments corresponding to the scenes and start key frames of the video segments; an executing module 506 configured to code in sequence the video segments corresponding to the scenes according to the start key frames to generate coded video data and a corresponding scene information table, such that a player decodes the coded video data according to the scene information table.

According to this embodiment of the present disclosure, the partitioning standard and the coding standard for the video are unified by way of determining in advance the partitioning information of the video data in accordance with the scenes by the information determining module, partitioning the video data by the segment determining module according to the partitioning information to determine the video segments corresponding to the scenes and the start key frames of the video segments, and coding in sequence the video segments corresponding to the scenes by the executing module according to the start key frames to generate the coded video data and the corresponding scene information table. The video segments are partitioned by the scenes, and each video segment is coded starting from the start key frame thereof, in this way, the compression ratio of the video data can be increased while the compression effect of each scene is ensured.

In regard to this device embodiment, it is just simply described as being substantially similar to the corresponding method embodiment, the correlations there between just refer to part of descriptions of the method embodiment.

### A Sixth Embodiment

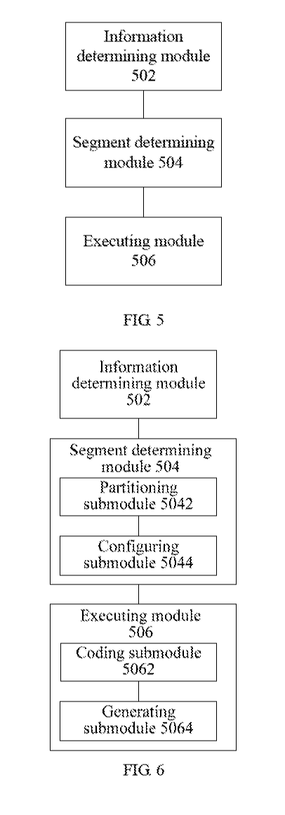

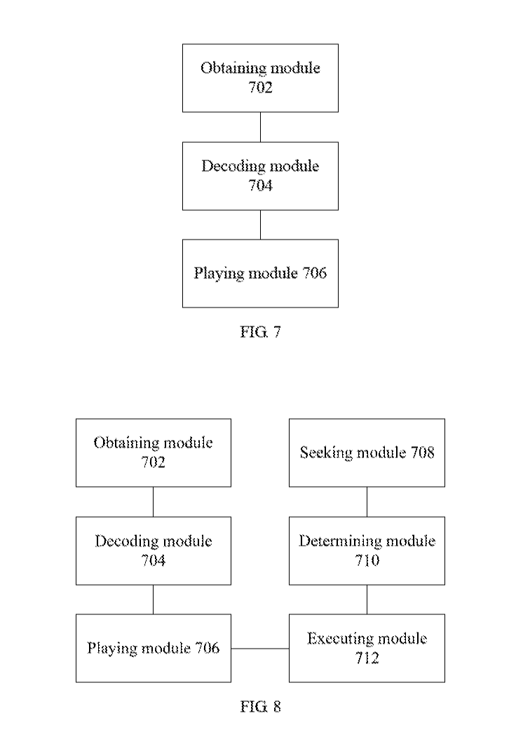

By referring to FIG. 6, which shows the structure block diagram of the video compressing device of another embodiment of the present disclosure, the device may specifically include the modules as follows.

An information determining module 502 configured to determine in advance scene identifiers of scenes and switching time corresponding to each scene identifier as partitioning information; a segment determining module 504 configured to partition video data according to the partitioning information to determine video segments corresponding to the scenes and start key frames of the video segments; an executing module 506 configured to code in sequence the video segments corresponding to the scenes according to the start key frames to generate coded video data and a corresponding scene information table, such that a player decodes the coded video data according to the scene information table.

The segment determining module 504 therein includes a partitioning submodule 5042 configured to partition the video data according to the switching time in the partitioning information to determine the video segments corresponding to the scene identifiers, and a configuring submodule 5044 configured to configure a start frame of each video segment as the start key frame, wherein the start key frame includes I frame.

The executing module 506 includes a coding submodule 5062 configured to separately perform coding compression on the video segments to generate the coded video data, and a generating submodule 5064 configured to record in the coding compression process position information of the start key frames of the video segments to generate the scene information table.

According to this embodiment of the present disclosure, the partitioning standard and the coding standard for the video are unified by way of determining in advance the scene identifiers of the scenes and the switching time corresponding to each scene identifier as the partitioning information, partitioning the video data according to the switching time in the partitioning information to determine the video segments corresponding to the scene identifiers, configuring the start frames of the video segments as the start key frames, separately performing coding compression on the video segments to generate the coded video data, and recording in the coding compression process the position information of the start key frames of the video segments to generate the scene information table. The video segments are partitioned by the scenes, and each scene has the scene identifier; moreover, each video segment is coded starting from the start key frame thereof. In this way, the compression ratio of the video data can be increased while the compression effect of each scene is ensured. The position information of the start key frame of each video segment in the entire video data to provide a basis for subsequent video decoding, playing, editing, etc.

### A Seventh Embodiment

By referring to FIG. 7, which shows the structure block diagram of the video playing device of one embodiment of the present disclosure, the device may specifically include modules as follows.

An obtaining module 702 configured to obtain coded video data and seek a scene information table corresponding to the coded video data; a decoding module 704 configured to determine start key frames of video segments according to the scene information table and decode in sequence the video segments according to the start key frames; a playing module 706 configured to play in sequence the decoded video data in accordance with the video segments.

According to this embodiment of the present disclosure, the obtaining module is used to obtain the coded video data and seek the scene information table corresponding to the coded video data; the decoding module is used to determine the start key frames of the video segments according to the scene information table and decode the video segments in sequence according to the start key frames; the playing module is used to play the decoded video data in sequence in accordance with the video segments. As a result, decoding is based on the scene information table in the coding process to ensure that the start frame of each video segment is the start key frame when the video segment is decoded; therefore, a player is able to quickly decode the video data of the video segment by means of the start key frame.

### An Eighth Embodiment

By referring to FIG. 8, which shows the structure block diagram of the video playing device of another embodiment of the present disclosure, the device may specifically include modules as follows.

An obtaining module 702 configured to obtain coded video data and seek a scene information table corresponding to the coded video data; a decoding module 704 configured to determine start key frames of video segments according to position information in the scene information table and decode in sequence the video segments starting from the start key frames, wherein each start key frame include I frame; a playing module 706 configured to play in sequence the decoded video data in accordance with the video segments; a seeking module 708 configured to determine a current scene of a video segment corresponding to current video playing time when a seek command is received, a position determining module 710 configured to seek position information of an adjacent scene corresponding to the current scene in the scene information table; an executing module 712 configured to determine a start key frame of the adjacent scene according to the position information and play a video segment of the adjacent scene starting from the start key frame.

According to this embodiment of the present disclosure, the coded video data is obtained and the scene information table corresponding to the coded video data is sought; the start key frames of video segments are determined according to the position information in the scene information table and the video segments are decoded starting from the start key frames; the decoded video data is played in sequence in accordance with the video segments. As a result, decoding is based on the scene information table in the coding process to ensure that the start frame of each video segment is the start key frame when the video segment is decoded; therefore, a player is able to quickly decode the video data of the video segment by means of the start key frame.

This embodiment of the present disclosure also provides users a new mode of watching a video. On the basis of video data obtained after decoding, the number of scenes included in the video data can be obtained, and a thumbnail of a scene corresponding to each video segment can be conveniently obtained at the beginning of the video segment. Therefore, the general content of the video can be obtained quickly.

According to this embodiment of the present disclosure, the scenes can be switched to play in units of an entire scene by means of fast forward or fast backward operations.

The device embodiments described above are merely schematic, wherein the modules illustrated as separate components may be physically separated or not. Components displayed as modules may be physical modules or not, which can be located at the same place or distributed to a plurality of network modules. Part or all modules may be selected according to actual requirements to achieve the purposes of the solutions of the embodiments. A person skilled in the art can understand and implement the solutions without creative work.

Each embodiment in the description is described in a progressive manner. Descriptions emphasize on the differences of each embodiment from other embodiments, and same or similar parts of various embodiments just refer to each other.

A person skilled in the art should understand that the embodiments of the present disclosure may be provided as methods, devices, or computer program products. Hence, the embodiments of the present disclosure may be in the form of complete hardware embodiments, complete software embodiments, or a combination of embodiments in software and hardware aspects. Moreover, the embodiments of the present disclosure may be in the form of computer program products executed on one or more computer-readable storage mediums containing therein computer-executable program codes (including but not limited to a magnetic disk memory, a CD-ROM, an optical memory, etc.).

Embodiments of the present disclosure further provide a non-volatile computer-readable storage medium, the non-volatile computer-readable storage medium is stored with computer executable instructions which are configured to perform any of the embodiments described above of the video compressing method.

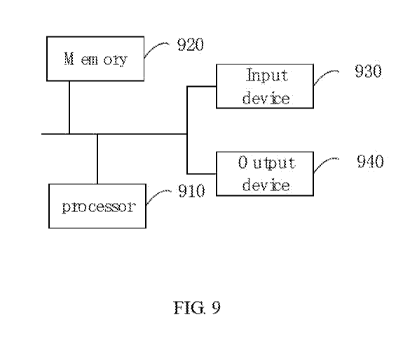

FIG. 9 illustrates a block diagram of an electronic device for executing the method according the disclosure, such as an application server. As shown in FIG. 9, the electronic device includes:

one or more processors 910 and memories 920, in FIG. 9, one processor 910 is taken as an example.

The electronic device for executing the video compressing method may include: an input device 930 and an output device 940.

The processor 910, the memory 920, the input device 930 and the output device 940 are connected through buses or other connecting ways. In FIG. 9, a bus connection is taken as an example.

The memory 920 is a non-transitory computer readable storage medium which may be used to store non-transitory software program, non-transitory computer-executable program and modules such as the program instructions/modules (such as the information determining module 502, the segment determining module 504 and the executing module 506 shown in FIG. 5) corresponding to the video compressing method according to the embodiment of the present disclosure. The processor 910 executes various functions and applications of the electronic device and performs data processing by operating the non-transitory software programs, instructions and modules stored in the memory 920, that is, executes the video compressing method according to the method embodiments above.

The memory 920 may include a program storage section and a data storage section. Wherein the program storage section may store operating system and application needed by at least one function, and the data storage section may store the established data according to the device for adjusting the video. In addition, the memory 920 may include a high-speed random access memory, and may also include a non-transitory memory such as at least a disk memory device, flash memory device or other non-transitory solid-state storage devices. In some embodiments, the memory 920 may include a remote memory away from the processor 910. The remote memory may be connected to the device for adjusting the video via network. The network herein may include Internet, interior network in a company, local area network, mobile communication network and the combinations thereof.

The input device 930 may receive input numbers or characteristics information, and generate key signal input relative to the user setting and function control of the device for adjusting the video. The output device 940 may include display devices such as a screen.

The one or more modules are stored in the memory 920, when executed by the one or more processors 910, the video compressing method in the above method embodiments are executed.

The product may execute the method provided according to the embodiment of the present disclosure, and it has corresponding functional modules and beneficial effects corresponding to the executed method. The technical details not illustrated in the current embodiment may be referred to the method embodiments of the present disclosure.

The embodiments of the present disclosure are described with reference to the flow diagrams and/or the block diagrams of the method, a terminal device (system), and the computer program product(s) according to the embodiments of the present disclosure. It should be appreciated that computer program commands may be adopted to implement each flow and/or block in each flow diagram and/or each block diagram, and a combination of the flows and/or the blocks in each flow diagram and/or each block diagram. These computer program commands may be provided to a universal computer, a special purpose computer, an embedded processor or a processor of another programmable data processing terminal equipment to generate a machine, such that the commands executed by the computer or the processor of another programmable data processing terminal equipment create a device for implementing functions specified in one flow or multiple flows of each flow diagram and/or one block or multiple blocks of each block diagram.

These computer program commands may also be stored in a computer-readable memory that is capable of guiding the computer or another programmable data processing terminal equipment to work in a specified mode, such that the commands stored in the computer-readable memory create a manufacture including a command device for implementing functions specified in one flow or multiple flows of each flow diagram and/or one block or multiple blocks of each block diagram.

Further, these computer program commands may be loaded on the computer or another programmable data processing terminal equipment, such that a series of operation steps are executed on the computer or another programmable data processing terminal equipment to generate processing implemented by the computer; in this way, the commands executed on the computer or another programmable data processing terminal equipment provide steps for implementing functions specified in one flow or multiple flows of each flow diagram and/or one block or multiple blocks of each block diagram.

The electronic device in embodiment of the present disclosure may have various types, which include but are not limited to:

(1) a mobile terminal device having the characteristics of having mobile communication functions and mainly aiming at providing voice and data communication. This type of terminals include mobile terminals (such as iPhone), multi-functional mobile phones, functional mobile phones and lower-end mobile phones, etc.;

(2) an ultra portable personal computing device belonging to personal computer scope, which has computing and processing ability and has mobile internet characteristic. This type of terminals include personal digital assistant (PDA) devices, mobile internet device (MID) devices and ultra mobile personal computer (UMPC) devices, such as iPad;

(3) a portable entertainment device which may display and play multi-media contents. This type of devices include audio players, video players (such as an iPod), handheld game players, e-books, intelligent toy, and portable vehicle-mounted navigation devices;

(4) a server providing computing service, the server includes a processor, a hard disk, a memory and a system bus. The server has the same architecture as a computer, whereas, it is required higher in processing ability, stableness, reliable ability, safety, expandable ability, manageable ability etc. since the server is required to provide high reliable service;

(5) other electronic device having data interaction functions.

The device embodiment(s) described above is (are) only schematic, the units illustrated as separated parts may be or may not be separated physically, and the parts shown in unit may be or may not be a physical unit. That is, the parts may be located at one place or distributed in multiple network units. A skilled person in the art may select part or all modules therein to realize the objective of achieving the technical solution of the embodiment.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A video compressing method, comprising:
at an electronic device:
determining in advance partitioning information of video data in accordance with scenes;
partitioning the video data according to the partitioning information to determine video segments corresponding to the scenes and start key frames of the video segments;
coding in sequence the video segments corresponding to the scenes according to the start key frames to generate coded video data and a corresponding scene information table, such that a player decodes the coded video data according to the scene information table.

2. The method according to claim 1, wherein determining in advance the partitioning information of the video data according to the scenes comprises:
determining in advance scene identifiers of the scenes and switching time corresponding to each scene identifier as the partitioning information.

3. The method according to claim 2, wherein partitioning the video data according to the partitioning information to determine the video segments corresponding to the scenes and the start key frames of the video segments comprises:
partitioning the video data according to the switching time in the partitioning information to determine the video segments corresponding to the scene identifiers;
configuring a start frame of each video segment as the start key frame, wherein the start key frame comprises I frame.

4. The method according to claim 3, wherein coding in sequence the video segments corresponding to the scenes according to the start key frames to generate the coded video data and the corresponding scene information table comprises:
separately performing coding compression on the video segments to generate the coded video data; and
recording in the coding compression process position information of the start key frames of the video segments to generate the scene information table.

5. An electronic device for video compressing, comprising:
at least one processor, and
a memory communicably connected with the at least one processor for storing instructions executable by the at least one processor, wherein execution of the instructions by the at least one processor causes the at least one processor to:
determine in advance partitioning information of video data in accordance with scenes:
partition the video data according to the partitioning information to determine video segments corresponding to the scenes and start key frames of the video segments;
code in sequence the video segments corresponding to the scenes according to the start key frames to generate coded video data and a corresponding scene information table, such that a player decodes the coded video data according to the scene information table.

6. The electronic device according to claim 5, wherein the instructions causing the at least
one processor to determine in advance partitioning information of video data in accordance with scenes further comprise instructions to cause the at least processor to: determine in advance scene identifiers of the scenes and switching time corresponding to each scene identifier as the partitioning information.

7. The electronic device according to claim 6, wherein partition the video data according to the partitioning information to determine video segments corresponding to the scenes and start key frames of the video segments comprises:
partitioning the video data according to the switching time in the partitioning information to determine the video segments corresponding to the scene identifiers;
configuring a start frame of each video segment as the start key frame, wherein the start key frame comprises I frame.

8. The electronic device according to claim 6, wherein code in sequence the video segments corresponding to the scenes according to the start key frames to generate coded video data and a corresponding scene information table comprises:
separately performing coding compression on the video segments to generate the coded video data; and
recording in the coding compression process position information of the start key frames of the video segments to generate the scene information table.

9. A non-transitory computer readable medium storing executable instructions that, when executed by a play device, cause the play device to:
determine in advance partitioning information of video data in accordance with scenes;
partition the video data according to the partitioning information to determine video segments corresponding to the scenes and start key frames of the video segments;
code in sequence the video segments corresponding to the scenes according to the start key frames to generate coded video data and a corresponding scene information table, such that a player decodes the coded video data according to the scene information table.

10. The non-transitory computer readable medium according to claim 9, wherein
determine in advance partitioning information of video data in accordance with scenes comprises: determining in advance scene identifiers of the scenes and switching time corresponding to each scene identifier as the partitioning information.

11. The non-transitory computer readable medium according to claim 10, wherein partition the video data according to the partitioning information to determine video segments corresponding to the scenes and start key frames of the video segments comprises:
partitioning the video data according to the switching time in the partitioning information to determine the video segments corresponding to the scene identifiers;
configuring a start frame of each video segment as the start key frame, wherein the start key frame comprises I frame.

12. The non-transitory computer readable medium according to claim 10, wherein code in sequence the video segments corresponding to the scenes according to the start key frames to generate coded video data and a corresponding scene information table comprises:
separately performing coding compression on the video segments to generate the coded video data; and
recording in the coding compression process position information of the start key frames of the video segments to generate the scene information table.
